(19) United States
(12) Patent Application Publication
(10) Pub. No.: US 2026/0350581 A1
(43) Pub. Date: Nov. 5, 2026

(54) MULTI-PARTY PAYMENT INSTRUMENT

(71) Applicants: American Express Travel Related Services Company, Inc., New York, NY (US); AMEX Canada, Inc., North York (CA); American Express Services Europe Limited, London (GB)

(72) Inventors: Indiana Maria Baltodano, New York, NY (US); Manik Biswas, Burgess Hill (GB); Ashley Sjostrom Brailey, Garwood, NJ (US); Alaric M. Eby, Scottsdale, AZ (US); Magdalena McGoldrick, East York (CA); Margaret H. Ryan, Jersey City, NJ (US)

(21) Appl. No.: 19/195,587

(22) Filed: Apr. 30, 2025

(51) Int. Cl. G06Q 20/32; G06Q 20/40

(52) U.S. Cl. CPC G06Q 20/3278; G06Q 20/405; G06Q 20/407

(57) ABSTRACT

Disclosed are various embodiments for a multi-party payment instrument. A first computing device can obtain from a user via a user interface shown on the display of the first computing device a plurality of domain controls and a list of participants and send a request for a shared token to an issuer service, the request for the shared token including at least the domain controls and the list of participants. Moreover, the fist computing device can receive, from the issuer service, the shared token. Then, the first computing device can establish a near-field communication (NFC) connection with a second computing device using a NFC transceiver and send via the NFC connection, the shared token to the second computing device.

### BACKGROUND

Consumers often have a need to make and manage shared expenses when, for example, going out to dinner with friends or family, taking a group trip, buying a group gift, etc. Managing group expenses usually requires the participants to keep track of expenses and charge the relevant party. Further, when making group purchases, the individual making the payment on a credit card, for example, will benefit from earning points or rewards for the whole purchase, while those reimbursing the payor do not receive the benefit of rewards or points. Additionally, when a group purchase must be returned or canceled, the payor must take additional steps of paying back each individual participant their respective portions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface of the split payment program rendered by a client device according to various embodiments of the present disclosure.

FIG. 2 is a drawing depicting an example of a scenario of users performing a shared token transfer according to various embodiments of the present disclosure.

FIG. 3 is a drawing depicting an example of a scenario of a client device establishing an NFC connection with a Point of Sale (PoS) terminal to conduct a transaction using a shared token according to various embodiments of the present disclosure.

FIG. 4 is a drawing of a network environment according to various embodiments of the present disclosure.

FIG. 5 is a flowchart illustrating one example of functionality implemented as portions of a client application executed in a client device in the network environment of FIG. 4 according to various embodiments of the present disclosure.

FIG. 6 is a flowchart illustrating one example of functionality implemented as portions of an issuer service executed in a computing environment in the network environment of FIG. 4 according to various embodiments of the present disclosure.

FIG. 7 illustrates one example of functionality implemented as portions of a service executed in a computing environment in the network environment of FIG. 4 according to various embodiments of the present disclosure.

FIG. 8 illustrates one example of functionality implemented as portions of a service executed in a computing environment in the network environment of FIG. 4 according to various embodiments of the present disclosure.

### DETAILED DESCRIPTION

Disclosed are various approaches for a multi-party payment instrument, which can allow for multi-party payments. For example, the participants can create a shared account tapping their device with other participants'device in order to share the information required to create a shared account and to share a shared payment instrument, or shared token, associated with the shared account via a near-field communication (NFC) connection. In some examples, the shared account can hold multiple credentials represented by the one shared token. Further, in creating the shared account, the participants can establish instructions and restrictions for use of the multi-party shared payment instrument. In the various embodiments of the present disclosure, each participant can store the shared token, such that any participant can complete a transaction using the shared payment instrument. For example, when a participant conducts a contactless payment using the shared token, payment can be distributed between the payment credentials stored in the shared account. Accordingly, the various embodiments of the present disclosure allow for a transaction to be completed using the shared payment instrument, automatically dividing the transaction and splitting payment among the participant's credentials as determined by the instructions, and the respective payments being reflected on the respective individual's account.

Embodiments of the present disclosure provide several advantages relating to payment distribution among a group of individuals or among various payment instruments. Most existing methods and instruments for spilt payments are applied retroactively or after an individual has already funded the entire purchase and is being reimbursed. Alternatively, the present disclosure allows for multiple parties to participate in a transaction simultaneously at the point-of-sale. Further, the various embodiments of the present disclosure can enable all participating parties to earn points or rewards for their respective portion based on their individual payment method by splitting payment at the transaction. Further in some examples, various embodiments of the present disclosure can automatically credit participant accounts in the case of returns instead of requiring a paying party to track repayments. In all, the various embodiments of the present disclosure allow for group expenses to be seamlessly split and distributed among the respective parties.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

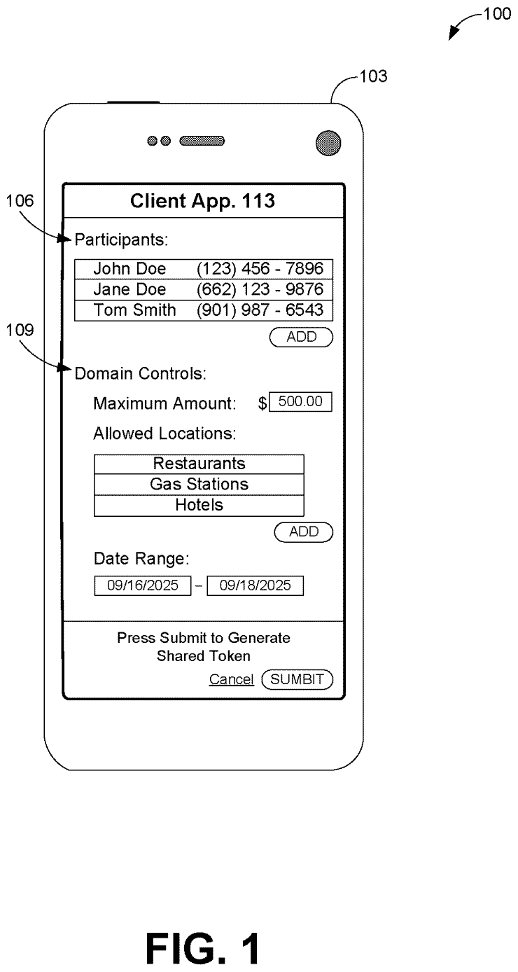

FIG. 1 illustrates one example of a user interface of the split payment program according to various embodiments of the present disclosure. For example, a client device 103 can render a user interface of the split payment program, or client application 113. In various examples of the present disclosure, the user interface can include a list of participants 106, various domain controls 109, and other suitable data entry elements. For example, the list of participants 106 can note each participant of a group engaging in the split payment program. In some examples of the present disclosure, the list of participants 106 can include information from each participant (e.g., name, phone number, or other identifying information). Various examples of the present disclosure can also include domain controls 109 presented in the user interface. The domain controls 109 can be set to establish boundaries for the split payment program for a respective group. As illustrated in FIG. 1, these domain controls 109 can include a maximum transaction amount, allowed merchant categories, date range, etc. Other domain controls 109 could also be provided by various embodiments of the present disclosure. The user interface can also include a submit option and a cancel option wherein the cancel option ends the session and the submit option generates the shared token. The shared token can be used by the participants of the list of participants 106 in the split payment program as a payment instrument according to various embodiments of the present disclosure.

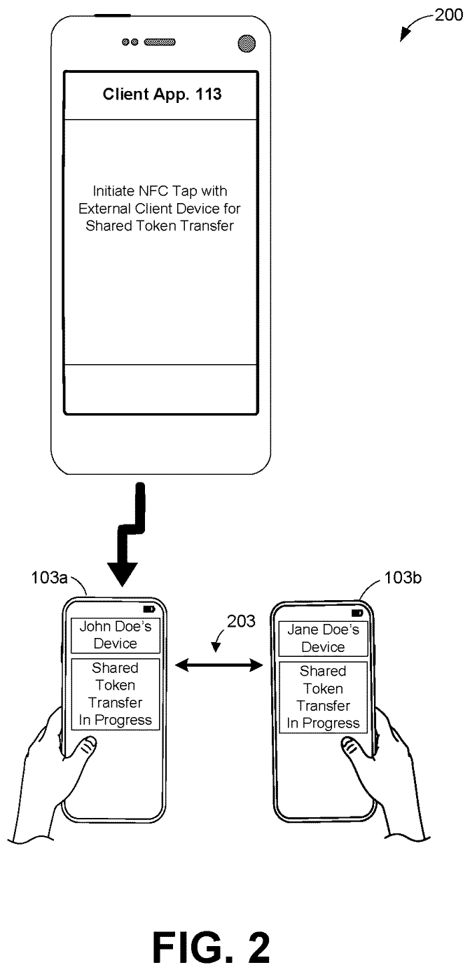

As illustrated in FIG. 2, shown is a network environment 200 of client devices 103 transferring a shared token between each other. The network environment 200 includes a first client device 103a, a second client device 103b (referred to generically as a “client device 103” and collectively as “the client devices 103”), and other suitable components, which are in data communication with each other via a wide area network.

In the illustrated example, the first client device 103a has a shared token. The first client device 103a and the second client device 103b can initiate a data session via a local area network 203 for sharing the shared token with the second participant. In some examples, the contactless network 206 is a near field communication (NFC) wireless protocol and the data session is an NFC session. For an NFC session, the client devices 103 can be placed in close proximity to each other (e.g., adjacent or near adjacent to each other) for maintaining data communication during the NFC session. Through the NFC session, the first client device 103a can transmit the shared token to the second client device 103b. However, other implementations could use other short-range wireless communication protocols, such as BLUETOOTH, ultra-wideband (UWB), or similar technologies.

In various embodiments of the present disclosure, the contactless network 206 allows the first client device 103a to share the shared token with the second client device 103b. For example, the user of the first client device 103a and the user of the second client device 103b can both be participants of a split payment program. The transfer of the shared token as shown in FIG. 2 is one example of the shared token being transferred between participants.

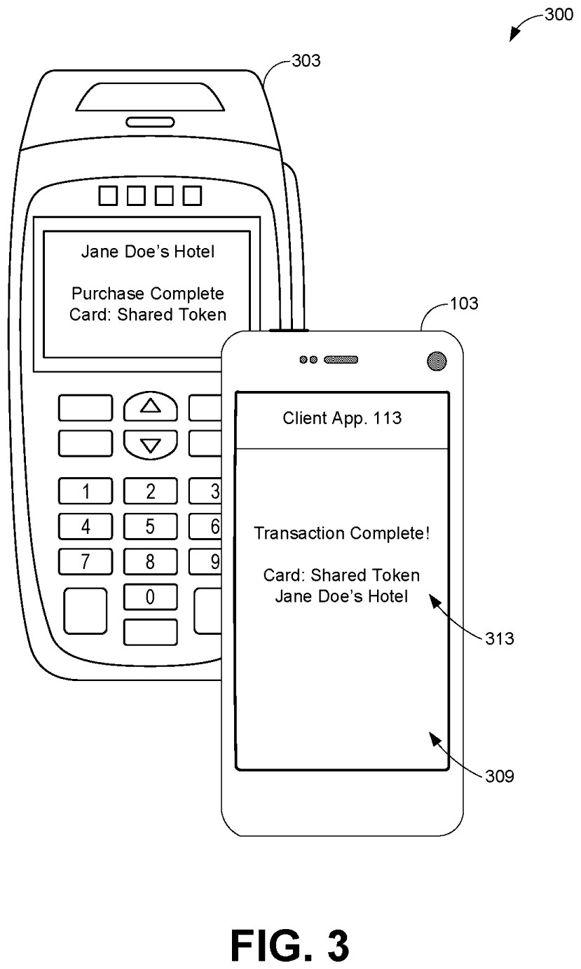

As illustrated in FIG. 3, shown is an example scenario of a transaction authorization for a transaction using a shared token in a network environment 300. The network environment 100 includes a client device 103 and a point-of-sale (PoS) terminal 303. In FIG. 1, the user interface of the PoS terminal 303 indicates that the PoS terminal 303 completed a transaction with the client device 103. The user interface 309 of the client device 103 includes transaction authorization 313 that confirms the completion of the transaction in indicating “Transaction Complete!”. The authorization notification indicates that the shared token was used to the transaction. In this non-limiting example, the client device 103 and the PoS terminal are using a near-field communication (NFC) protocol for the contactless transaction.

For example, the PoS terminal 303 can retrieve the shared token from the client device 103 via an NFC protocol for a purchase. The shared token can be stored as a payment instrument in a digital wallet application for the client device 103. The shared token can be linked to several payment instruments for a plurality of participants in a split payment program. Each payment instrument can have a different respective user with different restrictions and benefits. In completing the transaction using the shared token, payment can be distributed among a set of participants associated with the shared token.

Additionally, there can be various limitations set by in the account associated with the shared token restricting some transactions based at least in part on domain controls (e.g., limits on merchant categories, maximum approved amounts, date ranges, etc.). If the transaction fails to follow at least one of the domain controls, the transaction can be declined via the shared token.

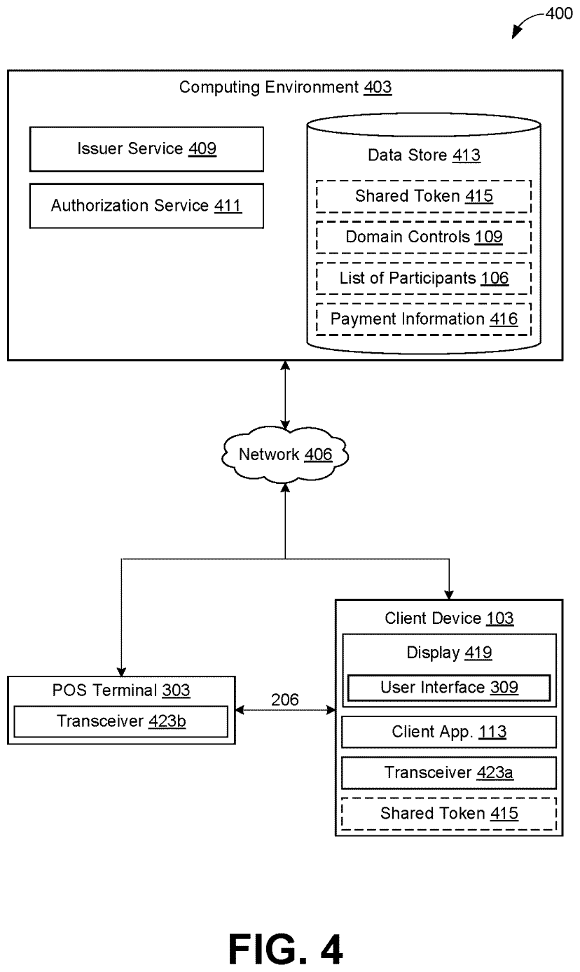

With reference to FIG. 4, shown is a block diagram of the network environment 200 according to various embodiments. The network environment 200 can include a computing environment 403, a client device 103, and a point-of-sale (PoS) terminal 303, which can be in data communication with each other via a network 406.

The network 406 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 406 can also include a combination of two or more networks 406. Examples of networks 406 can include the Internet, intranets, extranets, virtual private networks (VPNs), and similar networks.

The client device 103 and the PoS terminal 303 can be in data communication by way of a contactless network 206. The contactless network 206 can enable direct communication between the client device 103 and the PoS terminal 303 without the involvement of the network 406. IN some examples, the contactless network 206 can represent one or more near-field communication (NFC) protocols, one or more BLUETOOTH protocols, or other suitable local contactless networks 206. The contactless network 206 can be used to contactless payment. One non-limiting examples of contactless payment would be according to a version of the EUROPAY®, MASTERCARD®, and VISA® (EMV) contactless payment standard.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 include issuer service 409, authorization service 411, and other applications, services, processes, systems, engines, or functionality not discussed in detail herein.

The issuer service 409 can be executed to generate a shared token 415. For example, the issuer service 409 can receive the list of participants 106, the participants'payment credentials, and various domain controls 109. Based at least in part on receiving this data, the issuer service 409 can generate a shared token 415 that represents a single payment instrument to be shared among the list of participants 106. The issuer service 409 can store the participants'payment credentials so that when a transaction is completed using the shared token 415, the authorization service 411 can distribute payment among the participants'payment credentials according to the established distribution rules.

For example, there could be three participants in a list of participants 106 participating in the split payment program to divide payment obligations evenly via the shared token 415. In this example, a first participant can use the shared token 415 for an agreed upon shared expense. The expense can be agreed upon by the group or it could be approved as appropriate according to the set domain controls 109. For example, the authorization service 411 can confirm that the pending transaction is approved by the set domain controls 109 and approved by the payment credentials of each participant stored with the issuer service 409. If the issuer service 409 deems the transaction acceptable according to the stored information, the authorization service 411 can approve the transaction and allow it to process. In various embodiments of the present disclosure, in processing the transaction, the authorization service 409 can distribute 33.3% of the payment obligation to the first participant, 33.3% of the payment obligation to the second participant, and 33.3% of the payment obligation to the third participant. Thus, the authorization service 409 can split the payment obligation among the participants. In some examples, the split can be equal as previously described or in other example, the split can be determined by percentages or other calculations set by the participants.

Further, in some examples, the issuer service 409 can send an approval request to the participants of the list of participants 106 after the transaction has occurred. In this example, a first participant can complete a transaction using the shared token 415. However, as the group has opted to approve transactions retroactively, the payment credentials of the first participant would be obligated to complete the transaction until the group approves the transaction and approves an appropriate split.

Also, various data is stored in a data store 413 that is accessible to the computing environment 403. The data store 413 can be representative of a plurality of data stores 413, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 413 is associated with the operation of the various applications or functional entities described below. This data can include a shared token 415, domain controls 109, a list of participants 106, and payment information 416, and potentially other data.

The shared token 415 can represent an account number of a payment instrument stored on a client device 103, such as a card number stored on a physical payment card (e.g., NFC-based payment card) or a card number stored in a wallet application or a client application 113 executed in the client device 103. The shared token 415 can be linked to multiple account credentials (e.g., credit cards, debit cards, checking cards, gift cards, etc.) of the respective participants in the split payment program. For example, during a transaction at the PoS terminal 303, the client device 103 provides the shared token 415 to the PoS terminal 303. Subsequently, the issuer service 409 can pay a merchant using a single payment method, and at the same time fund the single payment method by retrieving funds from the linked accounts according to the payment distribution rules.

The list of participants 106 can represent a list of individuals or accounts participating in the split payment program. In some examples, the list of participants 106 can list all the individuals of a group completing a group purchase. In other examples, the list of participants can represent a list of accounts being used for a split payment wherein more than one account could be linked to one user, allowing the user to split payment among more than one payment instruments. For each of the individuals or accounts of the list of participants, the participant's information (e.g., phone number) can be saved to the account associated with shared token 415. In some examples, the list of participants can include a payment distribution list. The payment distribution can be set as an equal split among participants, a set percentage for each participant where the percentage varies among the participants, an amount limit for each participant, or any other applicable payment split calculation.

The domain controls 109 can represent instructions and limitations set for the shared token 415. In various examples, the domain controls 109 can include a maximum approved transaction amount, a list of allowed merchant categories, a date range, a payment distribution list, and other appropriate transaction restraint. For example, a domain control 109 could be set for a maximum transaction amount of $500.00, therefore any transaction for an amount over $500.00 would be declined. A maximum amount could be set on a per transaction basis or a total purchases basis. Further, a maximum amount could be set per participant based at least in part on their payment distribution amount. For example, a first participant could agree to pay thirty percent (30%) and have a maximum amount set at $300, a second participant could agree to pay sixty percent (60%) and have a maximum amount set at $600, and a third participant could agree to pay ten percent (10%) and have a maximum amount set at $200. Although the third participant has their maximum amount set to $200, the maximum amount they will be charged would be $100 in accordance with the maximum amounts set by the first and second participants in respect to the payment distribution percentages. In some examples, the domain controls 109 could include a list of approved merchant categories. For example, the approved merchant categories could include hotels and gas stations for a group trip where participants wish to split the payment for lodging and gas costs. In this example, an attempt to use the shared token 415 at a grocery store would be declined due to failing to comply with the set domain controls 109. Further, in various example, the domain controls 109 could include a date range. Following the example above of a group trip, the trip could be for specific date from Sep. 16, 2025, to Sep. 18, 2025. A domain control 109 for this date range could restrict authorizations for purchases made the shared token 415 such that only purchases made within this date range would be authorized.

The payment information 416 can represent the payment credentials for each participant of the list of participants 106. For example, the payment information 416 can correspond to a credit card account, debit card account, gift card or similar stored value payment instrument, bank account (e.g. checking account or other demanded deposit account), etc., for each respective participant. For example, a first participant could upload a credit card account for payment and a second participant could upload a debit card account for payment and both payment methods could be stored as payment information 416.

The client device 103 is representative one or more of a plurality of client devices (e.g., the first client device 103a, the second client device 103b, etc.) that can be coupled to the network 406. In some examples, the client device 103 can communicate via the contactless network 206. The client device 103 can also include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 419, such as liquid crystal displays (LCDs), gas plasma-based flat panel displays, organic light emitting diode (OLED) displays, electrophoretic ink (“E-ink”) displays, projectors, or other types of display devices. In some instances, the display 419 can be a component of the client device 103 or can be connected to the client device 103 through a wired or wireless connection.

The client device 103 can include a transceiver 423a and other suitable devices. The transceiver 423a can represent one or more components that communicate according to various wireless communication protocols, such as over the network 406 or the contactless network 206. Accordingly, the client device 103 can represent a wireless-enabled mobile (e.g., and NFC-enabled mobile device) of a wireless-enabled payment card (e.g., an NFC-enabled payment card). For example, the transceiver 423a can represent a near-field communication (NFC) transceiver that communicates according to one or more NFC communication protocols or over the contactless network 206. In this instance, the contactless network 206 can represent one or more NFC communication protocols that are used to execute a contactless data transaction between the client device 103 and the PoS terminal 303. Additionally, the transceiver 423a can represent other wireless transceivers, such as a Wi-Fi transceiver, a cellular transceiver, a BLUETOOTH transceiver, and other suitable wireless transceivers.

The client device 103 can be configured to execute various applications such as a client application 113 or other applications. The client application 113 can be executed in a client device 103 to access network content served up by the computing environment 403 or other servers, thereby rendering a user interface 309 on the display 419. To this end, the client application 113 can include a browser, a dedicated application, or other executable, and the user interface 309 can include a network page, an application screen, or other user mechanism for obtaining user input. The client device 103 can be configured to execute applications beyond the client application 113 such as email applications, social networking applications, word processors, spreadsheets, or other applications. In some examples, the client application 113 can represent a banking application (e.g., the split payment program).

The PoS terminal 303 can represent a device that is configured for executing a contactless transaction with the client device 103. The PoS terminal 303 can include a transceiver 423b for data communications. The transceiver 423b can represent one or more components that communicate according to various wireless communication protocols, such as over the network 406 or the contactless network 206. For example, the transceiver 423b can represent a near-filed communication (NFC) transceiver that communicates according to one or more NFC communication protocols or over the contactless network 206. Additionally, the transceiver 423b can represent other wireless transceivers, such as Wi-Fi transceiver, a cellular transceiver, a BLUETOOTH transceiver, and other suitable wireless transceivers.

Next, a general description of the operation of the various components of the network environment 400 is provided. Although the following description provides one illustrative example of the operations of and interactions between the various components of the network environment 400, other operations and interactions are also encompassed by the various embodiments of the present disclosure. More detailed discussion of the operations of individual components is provided in the discussion accompanying the subsequent drawings.

To begin, the first client device 103a can display a user interface 309 requesting a list of participants 106 and domain controls 109 from a user. The user interface 309 can include an option for the user to submit the request information and to request for a shared token 415 to be generated. The first client device 103a can send a request for a shared token 415 to an issuer service 409. In various examples, the request for a shared token 415 can include the list of participants 106 and the domain controls 109. The issuer service 409 can generate the shared token 415 based at least in part on the list of participants 106. In some examples, the issuer service 409 can generate the shared token 415 further based at least in part on the domain controls 109.

Once the shared token 415 is generated, the issuer service 409 can transmit the shared token 415 to the participants. For example, the issuer service 409 can transmit the shared token 415 to the first client device 103a. Then the first client device 103a can transmit the shared token 415 to the other participants by an NFC connection for example. In some examples, the issuer service 409 can send the shared token 415 to all the participants from the list of participants 106. In some examples, the issuer service 409 can send the shared token 415 to the participants through email or text message. In further more examples, the issuer service 409 can transmit the shared token 415 to a client application 113 on the client device 103 of each participant in the split payment program group.

Each participant can then use the shared token 415 to complete a transaction. For example, a first client device 103a could complete a transaction by presenting the shared token 415 to a PoS terminal 303 via an NFC connection. The transaction can be approved by the authorization service 411 if the transaction complies with the domain controls 109 stored with or retrieved by the issuer service 409. In some examples, the transaction can be denied by the authorization service 411 if the transaction fails to comply with the domain controls 109. For example, the domain controls 109 can limit transactions to only Sep. 16, 2025, to Sep. 18, 2025. Therefore, a transaction initiated on Sep. 15, 2025, would be declined for failing to comply with the domain controls 109. If the transaction is declined, the user interface 309 of the first client device 103a could present an option to complete the transaction with a different payment credential. The first client device 103a could then reinitiate the transaction with the PoS terminal 303 using the alternative payment credential.

In the case of approval, the issuer service 409 can divide the payment among the participants from the list of participants. In some examples, the payment can be evenly distributed among participants. In other examples, the domain controls 109 can include a payment split distribution and the issuer service 409 can divide the payment of the transaction according to the payment split distribution. In these examples, the issuer service 409 can apply varying amounts from various accounts to fund a single payment to be sent to the merchant.

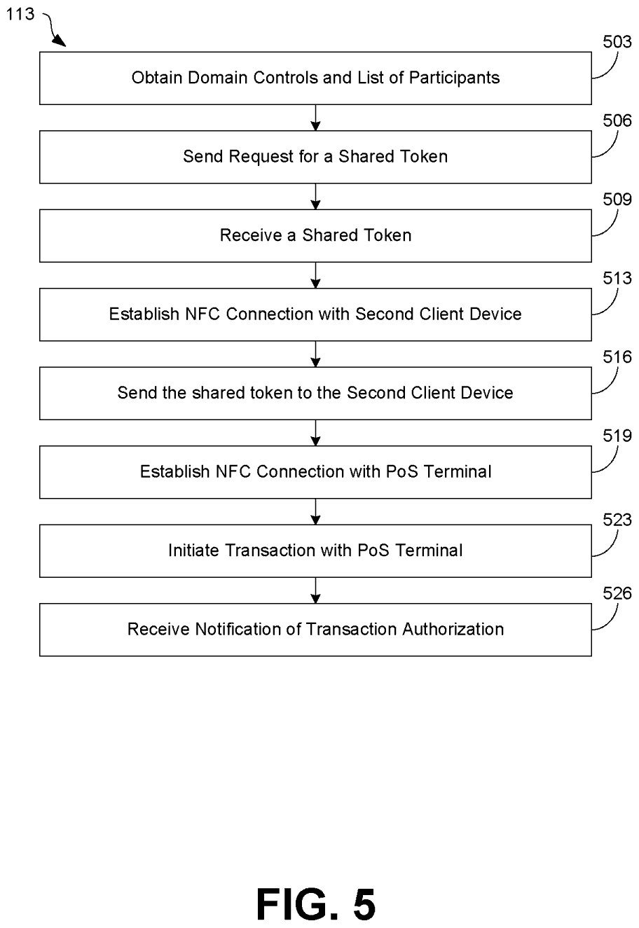

Referring next to FIG. 5, shown is a flowchart that provides one example of the operation of a portion of the client application 113. The flowchart of FIG. 5 provides merely an example of the many different types of functional arrangements that can be employed to implement the operation of the depicted portion of the client device 103. As an alternative, the flowchart of FIG. 5 can be viewed as depicting an example of elements of a method implemented within the network environment 400.

Beginning with block 503, a client application 113 being executed on a first client device 103a can obtain domain controls 109 and a list of participants 106. For example, the first client device 103a can display a user interface 309 requesting information from a user including at least domain controls and a list of participants. In some examples, the list of participants 106 can include identifying information of each participant of a group participating in a split payment program. Further, the domain controls 109 can be set by a user and can vary by group. For example, one group can set domain controls 109 for a maximum transaction amount and an approved date range and another group can opt to set domain controls 109 for a maximum approved total amount for the shared token 415 and a list of approved merchant categories. In various examples, these initial limitations established by the user can be edited by individual participants of the group and approved by each participant of the group.

Next at block 506, the client application 113 can send a request for a shared token 415. For example, the first client device 103a using the client application 113a can request a shared token 415 from the issuer service 409. In various examples of the present disclosure, the shared token 415 can be based at least in part on the list of participants 106 and the domain controls 109 determined at block 503.

Moving on to block 509, the client application 113 can receive the shared token 415. For example, the issuer service 409 can send the generated shared token 415 to the first client application 113a. In some examples, the issuer service 409 can send the shared token 415 to each participant from the list of participants 106.

Then at block 513, the client application 113 being executed on the first client device 103a can establish an NFC connection with a second client device 103b. For example, the first client device 103a can establish an NFC connection with a second client device 103b using the NFC transceiver 423a. In various example, a contactless network is established between the first client device 103a and the second client device 103b.

Referring next to block 516, the client application 113 can send the shared token 415 to the second client device 103b. For example, the first client device 103a can use the NFC connection established at block 513 to transmit the shared token 415 to the second client device 103b. In various examples, the client application 113 can retain a version of the shared token 415 stored and transmit a copy of the shared token 415 to the second client device 103b. Therefore, both the first client device 103a and the second client device 103b can store the shared token 415. Further, in some examples, the client application 113 can first encrypt the shared token 415 and transmit the encrypted shared token 415 to the second client device 103b.

Next at block 519, the client application 113 being executed on the first client device 103a can establish an NFC connection with a PoS terminal 303. For example, a participant can use the first client device 103a to complete a transaction using the shared token 415. To begin the transaction, the client application 113 being executed on the first client device 103a must first establish a connection with the PoS terminal 303. This interaction can is illustrated in FIG. 3. In some examples, the second client device 103b can be used to establish an NFC connection with the PoS terminal 303 to complete the transaction.

Moving on to block 523, the client application 113 can initiate a transaction with the PoS terminal 303. For example, the client application 113 can initiate the transaction with the PoS terminal 303 over the NFC connection established at block 519 using the shared token 415. In various examples, the client application 113 can initiate a transaction for a purchase to be divided among a group of participants in the split payment program.

Then at block 526, the client application 113 can receive notification of transaction authorization 313. For example, the issuer service 409 can receive a notification from the authorization service 411 indicating a transaction authorization 313. In some examples, the transaction authorization can indicate that the transaction was approved and in other examples, the transaction authorization 313 can indicate that the transaction was declined. In these examples, the issuer service 409 can send a notification to the client application 113 regarding the transaction authorization 313. Furthermore, in various applications the other participants from the list of participants 106 (e.g., the second client device 103b) can receive notice of the transaction authorization 313.

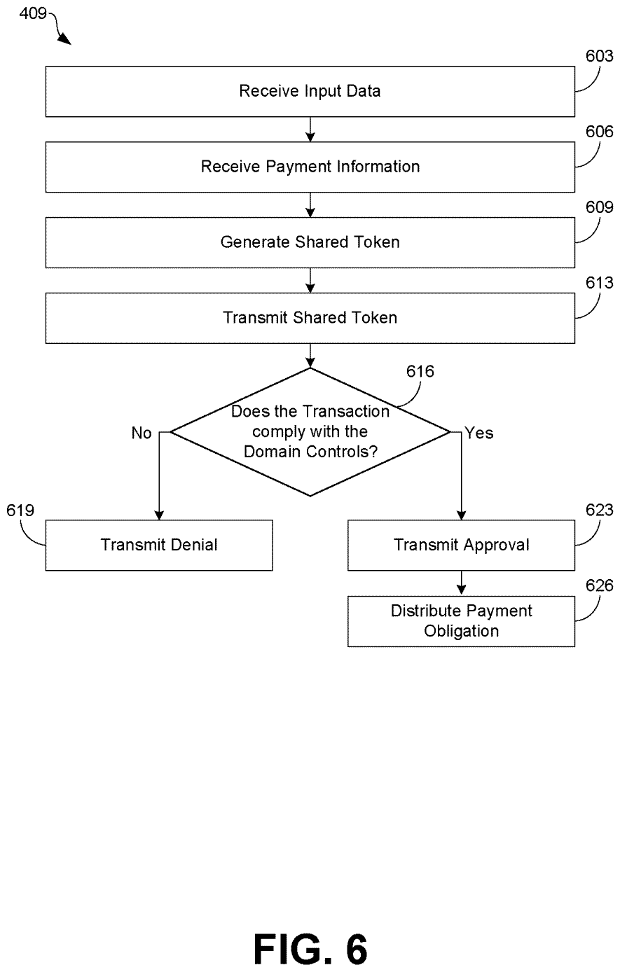

Moving on to FIG. 6, shown is a flowchart that provides one example of the operation of a portion of the issuer service 409. The flowchart of FIG. 6 provides merely an example of the many different types of functional arrangements that can be employed to implement the operation of the depicted portion of the issuer service 409. As an alternative, the flowchart of FIG. 6 can be viewed as depicting an example of elements of a method implemented within the network environment 400.

Beginning with block 603, the issuer service 409 can receive input data. In various examples, the input data can include a list of participants 106 or at least one domain control 109. For example, the issuer service 409 can receive from a client device 103 a list of participants 106. The issuer service 409 can also receive from a client device 103 domain controls 109 including a maximum amount, payment distributions rules, limitations on merchant categories, etc.

Next at block 606, the issuer service 409 can receive payment information. For example, the client device 103 can transmit the payment credentials from each of the participants to the issuer service 409. In other examples, the issuer service 409 can request payment information from each of the participants from the list of participants 106 received at block 603. In various examples, the payment information from each participant can be a variety of payment instruments (e.g., credit cards, debit cards, bank account information, gift cards, etc.).

Moving on to block 609, the issuer service 409 can generate the shared token 415. For example, the shared token 415 can be a digit token that represents a single payment instrument that divides payment obligation among the combined payment credentials of each of the participants. For example, the shared token 415 is a payment instrument that can be used to complete a transaction and based on a set payment distribution, split payment obligations among the participants in the split payment program.

Then at block 613, the issuer service 409 can transmit the shared token 415. For example, once the issuer service 409 generates the shared token 415, the issuer service 409 can transmit the shared token 415. In some examples, the issuer service 409 can send the shared token 415 to the client device 103 requesting the shared token 415 be generated. In other examples, the issuer service 409 can transmit the shared token 415 to all the participants in the group in the list of participants 106. And, in some examples, the issuer service 409 can transmit the shared token 415 to a client application 113. In these examples, the client application 113 can store the shared token 415 to be accessible by a client device 103 of each of the participants of the split payment program.

Next at block 616, the issuer service 409 can determine whether a transaction complies with the domain controls 109. Once the authorization service 411 receives a transaction authorization request, the authorization service 411 can verify with the issuer service 409 whether or not to approve the transaction based at least in part on the domain controls 109. For example, a transaction authorization for a transaction of $50 would comply with a domain control 109 set to only allow for transactions under $100. Alternatively, a transaction authorization request for a transaction of $100 would not comply with a domain control 109 set to only allow for transactions under $50. Further in some examples, the issuer service 409 can determine whether the credentials of each participant are approved for their respective portion of the transaction. Based at least in part on this analysis, the authorization service 411 can determine whether to approve or deny the transaction.

The method flows to block 619 when the issuer service 409 determined that the transaction does not comply with the domain controls 109 in block 616. In block 619, the issuer service 409 can receive a transaction authorization 313 indicating that the transaction was declined from the authorization service 411. Then, the issuer service 409 can transmit the denial notification to the merchant and the customer. For example, the issuer service 409 can communicate to the PoS terminal 303 that the transaction was declined. In some examples, the issuer service can transmit notice to the client device 103 that the transaction was denied. In various examples the present disclosure, the notice of denial transmitted to the client device 103 or the PoS terminal 303 can include a reason for the denial such as acknowledging which requirement of the domain controls 109 the transaction failed to meet. In some examples, the transaction can be declined due to insufficient funds in one or more of the participants'credentials. Further, in some examples, the client device 103 can present the user with a user interface 309 presenting alternative payment options to complete the transaction. The user can select an alternative payment option and reinitiate the transaction using the alternative payment option. And in some examples, despite the transaction being denied using the shared token 415, the user of the client device 103 can opt to be fully obligated for payment of the transaction and the shared token 415 can be used and approved for the transaction with the full amount of the transaction being credited from the user's payment credentials and not divided among the group.

Alternatively, the method can flow to block 623 when the issuer service 409 determines that the transaction complies with the domain controls 109 in block 619. In block 623, the issuer service 409 can transmit a transaction authorization 313 indicating that the transaction was approved by the authorization service 411. For example, the issuer service 409 can communicate to the PoS terminal 303 that the transaction was approved. In various examples, the issuer service 409 can transmit notice to the client device 103 that initiated the transaction that the transaction was approved. Further, in some examples, the issuer service 409 can send the transaction authorization 313 to all the participants in the split payment program from the list of participants 106.

Then at block 626, the issuer service 409 can distribute the payment obligation. For example, based at least in part on the distribution of payment established by the group or an even split among all participants from the list of participants 106, the issuer service 409 can split the payment of the transaction among the participants'credentials while simultaneously applying one payment to the merchant. For example, a group of five participants with a payment distribution established to be an even split can be charged by the issuer service 409 twenty percent (20%) of the transaction amount to the credentials stored for each participant by the issuer service 409.

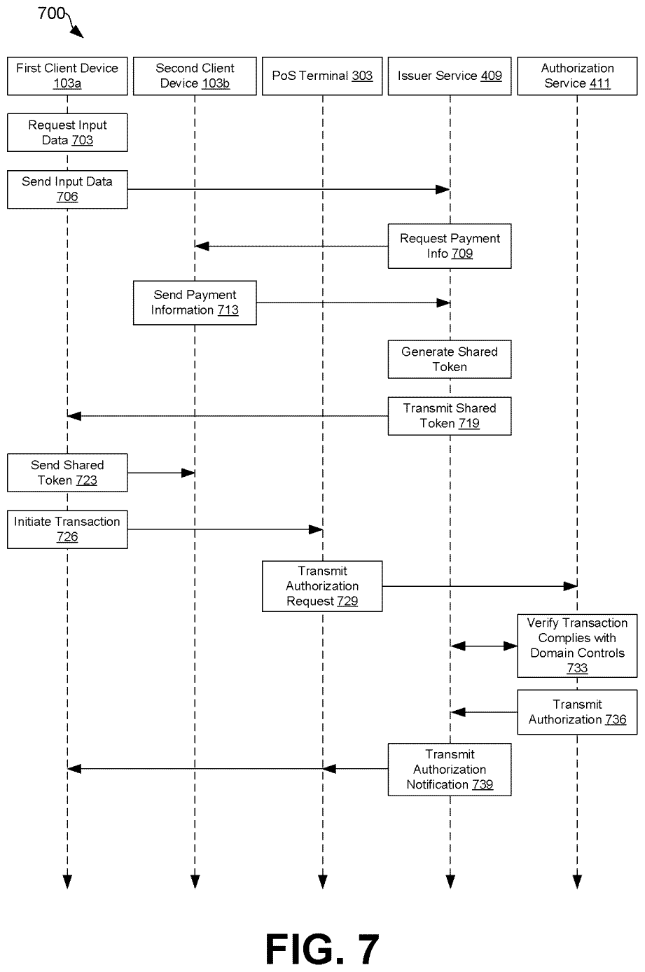

Moving on to FIG. 7, shown is a sequence diagram 700 that provides one example of the operation of a portion of the network environment 400. The sequence diagram 700 of FIG. 7 provides merely an example of the many different types of functional arrangements that can be employed to implement the operation of the depicted portion of the network environment 400. As an alternative, the sequence diagram 700 can be viewed as depicting an example of elements of a method implemented within the network environment 400.

Beginning with block 703, the first client device 103a can request input data. For example, a client application 113 executed on the first client device 103a can present a user interface 309 via the display 419 requesting input data from the user of the first client device 103a. In various examples, the input data requested by the first client device 103a can include a list of participants 106 and a set of one or more domain controls 109. In some examples, the input data can also represent payment credentials of the user of the first client device 103a or payment information for all participants.

In block 706, the first client device 103a can send the input data to the issuer service 409. For example, the client application 113 executed on the first client device 103a can send a list of participants 106 and a set of domain controls 109 to the issuer service 409.

Next at block 709, the issuer service 409 can request payment information from a second client device 103b. For example, the issuer service 409 can determine a second client device 103b from the received list of participants 106. Based at least in part on this determination, the issuer service 409 can request payment credentials to participant in the split payment program from a client application 113 executed on the second client device 103b. Although a second client device 103b is discussed, the second client device 103b is representative of any participant other than the first client device 103a. Therefore, there could be a third, fourth, fifth, sixth, etc. client device in this process represented by the second client device 103b. In some examples, the issuer service 409 can also request payment credentials from the first client device 103a.

Moving on to block 713, the second client device 103b can send the payment information to the issuer service 409. For example, the client application 113 executed on the second client device 103b could display a user interface 309 requesting information from the user of the second client device 103b. The second client device 103b can transmit the information input by the user to the issuer service 409.

Then at block 716, the issuer service 409 can generate the shared token 415. The shared token 415 can be generated based at least in part on the list of participants 106, the domain controls 109, and the payment credentials from the participants.

Referring next to block 719, the issuer service 409 can transmit the shared token 415 to the first client device 103a. In some examples, the issuer service 409 can send the shared token 415 to all the participants in the split payment program group.

Next at block 723, the first client device 103a can send the shared token 415 to the second client device 103b. For example, the first client device 103a can send the shared token 415 to the second client device 103b or other participant from the group via a text message, email, etc. In other examples, the first client device 103a can establish an NFC connection with the second client device 103b and transmit the shared token 415 via the NFC connection.

In block 726, the first client device 103a can initiation a transaction with a PoS terminal 303. For example, the first client device 103a can establish an NFC connection with the PoS terminal 303 and transmit the transaction request via the NFC connection. Further, in some examples, the first client device 103a can use the shared token 415 to complete a transaction with the PoS terminal 303.

Next at block 729, the PoS terminal 303 can transmit the authorization request to the authorization service 411. For example, the PoS terminal 303 can send the transaction request, the transaction amount, the transaction location, etc. to the authorization service 411.

Moving on to block 733, the authorization service 411 can verify the transaction complies with the domain controls 109 stored with the issuer service 409. For example, the authorization service 411 can determine whether the location of the transaction is allowed by the domain controls 109. In some examples, the issuer service 409 can verify that each participants'credentials are approved for the amount of its portion of the split payment and confirm this with the authorization service 411.

Then at block 736, the authorization service 411 can transmit the transaction authorization 313 to the issuer service 409. For example, the authorization service 411 can send to the issuer service 409 notice that the transaction has been declined based at least in part on the transaction failing to comply with at least one domain control. In other examples, the authorization service 411 can send to the issuer service 409 notice that the transaction has been approved.

Referring next to block 739, the issuer service 409 can send a similar transaction authorization 313 to the first client device 103a and the PoS terminal 303. In some examples, this notice can also be sent to the second client device 103b. The notice sent to the client device 103 and the PoS terminal 303 can include a reason for why the transaction was decline in the case of a denial (e.g., listing the domain control for which the transaction failed to comply with). The client device 103 can show the notice to a user via the display 419.

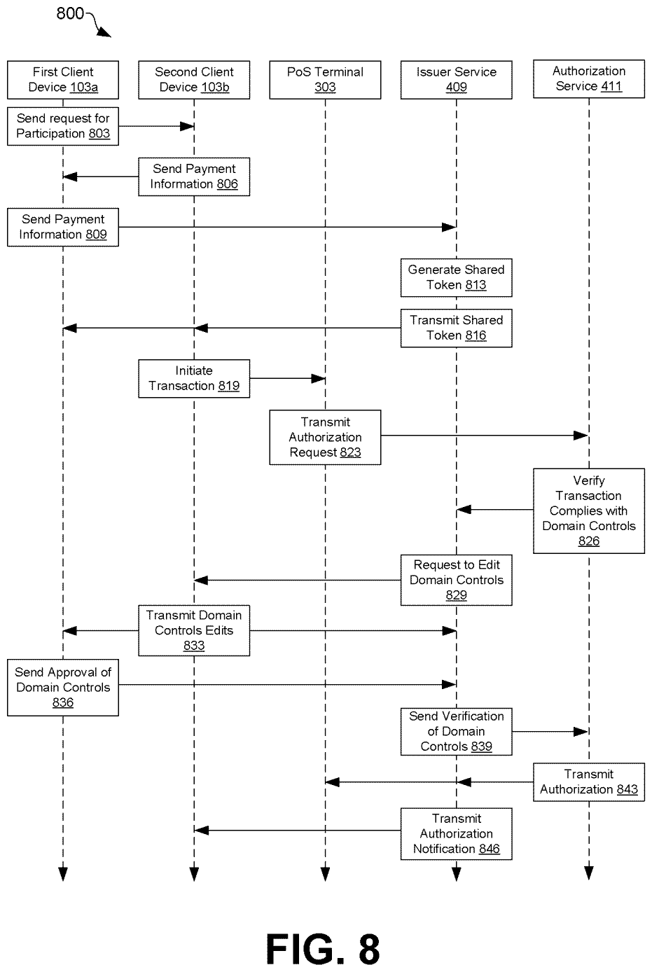

Referring next to FIG. 8, shown is a sequence diagram 800 that provides one example of the operation of a portion of the network environment 400. The sequence diagram 800 of FIG. 8 provides merely an example of the many different types of functional arrangements that can be employed to implement the operation of the depicted portion of the network environment 400. As an alternative, the sequence diagram 800 can be viewed as depicting an example of elements of a method implemented within the network environment 400.

Beginning with block 803, a first client device 103a can send a request for participation in a split payment program to a second client device 103b. In various examples, this request can be sent via a client application 113 executed on the first client device 103a and the second client device 103b. For example, the request for participation can include domain controls 109 suggested for the group by the user of the first client device 103a. The domain controls 109 can include, or example, a maximum spend amount, payment distribution rules, restricted merchant categories, etc.

In block 806, the second client device 103b can send payment information to the first client device 103a. For example, a user of the second client device 103b can agree to participant in the split payment program sent by the first client device 103a and in response send payment information of the user of the second client device 103b to the first client device 103a. In various examples, the client application 113 executed on the second client device 103b can encrypt the payment information and send the encrypted payment credentials to the first client device 103a. And, in some examples, the client application 113 executed on the second client device 103b can send the payment information directly to the issuer service 409. Further, in some examples, the second client device 103b can also send approval of the suggested domain controls 109.

Next at block 809, the first client device 103a can send the payment information to the issuer service 409. For example, the first client device 103a can send the payment information of the user of the first client device 103a and the payment information received from the second client device 103b to the issuer service 409. In various examples the client application 113 executed on the first client device 103a can encrypt the payment information and then send the encrypted payment information to the issuer service 409. In some examples, the payment information sent to he issuer service 409 can include a list of approved domain controls 109.

Moving on to block 813, the issuer service 409 can generate the shared token 415. The issuer service 409 can generate the shared token 415, based at least in part on the payment information received from the first client device 103a. For example, the shared token 415 can represent a single payment instrument that combines the payment credentials of the user of the first client device 103a and the user of the second client device 103b into a single payment method.

Then at block 816, the issuer service 409 can transmit the generated shared token 415. In some examples, the issuer service 409 can transmit the generated shared token 415 to the first client device 103a via the client application 113. In some examples, the issuer service 409 can transmit the generated shared token 415 to the second client device 103b. Further, for example, the issuer service 409 can send the shared token 415 to both the first client device 103a and the second client device 103b and any other participant in the list of participants 106.

Referring next to block 819, the second client device 103b can initiate a transaction with the PoS terminal 303. For example, the client application 113 executed on the second client device 103b can establish an NFC connection with the PoS terminal 303 and can initiate the transaction via the NFC connection.

Next at block 823, the PoS terminal 303 can transmit an authorization request of the transaction to the authorization service 411. For example, the PoS terminal 303 can request an indication of approval or denial of the transaction from the authorization service 411.

Then at block 826, the authorization service 411 can verify with the issuer service 409 that the transaction from the transaction authorization request complies with the domain controls 109. If there are no restrictions set by the domain controls 109 and only a split obligation, then, in some examples, this set may be omitted. In some examples, if the transaction is not approved by the issuer service 409 for not complying with the domain controls 109, the authorization service 411 can decline the transaction. Alternatively, if the transaction aligns with the domain controls 109, the authorization service 411 can approve the transaction. In some examples, the participants can adjust the domain controls 109 to allow for a certain transaction as described proceeding to block 829.

In block 829, the issuer service 409 can send a request to edit the domain controls 109 to the second client device 103b. For example, based at least in part on receiving the request domain controls 109 from the authorization service 409, the issuer service 409 can request to adjust the domain controls 109 to allow for the transaction by sending a request to the second client device 103b (in other examples the first client device 103a). This could be set by the participants to occur when the transaction is within a certain range of the domain controls 109 (e.g., within 15% of the allowed amount). In some examples, the domain controls 109 requested by the issuer service 409 can include a payment obligation split between the user of the first client device 103a and the second client device 103b. For example, the second client device 103b can set a domain control 109 spilt the payment with the user of the second client device 103b responsible for sixty percent (60%) of the transaction and the user of the first client device 103a responsible for forty percent (40%) of the transaction. If forty percent of the transaction is $50 and the user of the first client device 103a only approved amounts up to $40, then the issuer service 409 can send a request allowing for either the user of the first client device 103a to accept the amount over the set limit or the user of the second client device 103b to accept more than sixty percent of the transaction amount.

Next at block 833, the second client device 103b can transmit the domain control 109 to the issuer service 409 and the first client device 103a. In some examples, the second client device 103b can only send the domain controls 109 to the first client device 103a. In other examples, the second client device 103b can only send the domain controls 109 to the issuer service 409. In cases of the second client device 103b sending the domain controls 109 to only the issuer service 409, the issuer service can transmit the domain controls 109 to the first client device 103a (or other participants of the group) for approval or notice of the change.

Moving on to block 836, the first client device 103a can send approval of the domain controls 109 to the issuer service 409. For example, the client application 113 executed on the first client device 103a can send confirmation that the user of the first client device 103a agrees to be responsible for forty percent (40%) of the transaction and thus $50 (following the example used above). In some examples, the first client device 103a can also send this notice of approval to the second client device 103b. Further, in some examples, the first client device 103a could decline the change to the domain controls 109; in which case, the transaction can be declined. In various other examples, the first client device 103a could edit the domain controls 109 and send the edited domain controls 109 back to the second client device 103b or the issuer service 409, in a negotiation. For example, the first client device 103a could indicate that they do not wish to pay the $50 and wants to remain at their set limit of $40. The first client device 103a could send a request to the second client device 103b requesting that the user of the second client device 103b agree to pay more than their set sixty percent to cover the deficiency.

Then at block 839, the issuer service 409 can send verification of the domain controls 109 to the authorization service 411. In some examples, the transaction may have already been declined by the authorization service 411 due to a lapse in processing time. In these examples, the transaction can be reinitiated. Based in part on any revisions agreed upon for the domain controls 109, the transaction can be approved. If the transaction still does not comply with the agreed upon revisions or if there are no revisions, then the issuer service 409 can transmit to the authorization service 411 notice that the transaction does not comply with the domain controls 109.

Referring next to block 843, the authorization service 411 can transmit the transaction authorization 313 to the issuer service 409 and the PoS terminal 303. For example, when the transaction complies with the domain controls 109 the transaction authorization 313 can indicate that the transaction was approved. In other examples, when the transaction fails to comply with the domain controls 109 or when the participants fail to agree to domain controls 109 (e.g., split amount obligations) the transaction authorization 313 can indicate that the transaction was declined.

Finally at block 846, the issuer service 409 can send the same transaction authorization 313 from block 843 to the second client device 103b. In some examples, the transaction authorization 313 can also be sent to the first client device 103a (or other participants in the split payment program group). The client device 103 can display the notification of the transaction authorization 313.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 403.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a first computing device comprising a processor, a memory, a display, and a near-field communication (NFC) transceiver; and
machine-readable instructions stored in the memory that, when executed by the processor, cause the first computing device to at least:
obtain, from a user via a user interface shown on the display of the first computing device, a plurality of domain controls and a list of participants;
send a request for a shared token to an issuer service, the request for the shared token including at least the domain controls and the list of participants;
receive, from the issuer service, the shared token;
establish an NFC connection with a second computing device using the NFC transceiver; and
send, via the NFC connection, the shared token to the second computing device.

2. The system of claim 1, wherein the NFC connection is a first NFC connection and the machine-readable instructions, when executed by the processor, cause the first computing device to at least:
establish a second NFC connection with a point-of-sale (PoS) terminal; and
initiate a transaction with the PoS terminal over the second NFC connection using the shared token.

3. The system of claim 2, wherein the machine-readable instructions, when executed by the processor, cause the first computing device to at least:
obtain, from the second computing device, a payment distribution calculation; and
send an approval of the payment distribution calculation to the issuer service.

4. The system of claim 2, wherein the machine-readable instructions, when executed by the processor, further cause the first computing device to at least receive a notification from the issuer service that the transaction is approved, wherein the shared token distributes payment of the transaction among the list of participants according to the plurality of domain controls.

5. The system of claim 2, wherein the user interface is a first user interface and the machine-readable instructions, when executed by the processor, further cause the first computing device to at least:
receive a notification from the issuer service that the transaction is declined, wherein the transaction fails to comply with at least one of the plurality of domain controls;
present an option to complete the transaction with one or more alternative payment credentials through a second user interface shown on the display of the first computing device; and
reinitiate the transaction with the PoS terminal over the second NFC connection using one of the one or more alternative payment credentials.

6. The system of claim 1, wherein the shared token represents a payment instrument that is used to distribute payment among the list of participants according to the plurality of domain controls.

7. The system of claim 1, wherein at least one of the plurality of domain controls is one of at least a date range, a location restriction, a maximum amount, or a payment distribution list.

8. A method, comprising:
obtaining, by a first computing device, a plurality of domain controls and a list of participants from a user via a user interface shown on a display of the first computing device;
sending, by the first computing device, a request for a shared token to an issuer service, the request for the shared token including at least the domain controls and the list of participants;
receiving, by the first computing device, the shared token from the issuer service;
establishing, by the first computing device, an NFC connection with a second computing device using a near-field communication (NFC) transceiver; and
sending, via the NFC connection, the shared token from the first computing device to the second computing device.

9. The method of claim 8, wherein the shared token represents a payment instrument number that is used to distribute payment among the list of participants according to the plurality of domain controls.

10. The method of claim 8, wherein at least one of the plurality of domain controls is one of at least a date range, a location restriction, a maximum amount, or a payment distribution list.

11. The method of claim 8, further comprising:
establishing, by the second computing device, a second NFC connection with a point-of-sale (PoS) terminal; and
initiating, by the second computing device, a transaction with the PoS terminal over the second NFC connection using the shared token.

12. The method of claim 11, further comprising:
obtaining, by the first computing device and from the second computing device, a payment distribution calculation; and
sending, by the first computing device, an approval of the payment distribution calculation to the issuer service.

13. The method of claim 11, further comprising receiving, by the first computing device, a notification from the issuer service that the transaction is approved, wherein the shared token distributes payment of the transaction among the list of participants according to the plurality of domain controls.

14. The method of claim 11, wherein the user interface is a first user interface, further comprising:
receiving, by the second computing device, a notification from the issuer service that the transaction is declined, wherein the transaction fails to comply with at least one of the plurality of domain controls;
presenting an option to complete the transaction with one or more alternative payment credentials through a second user interface shown on the display of the second computing device; and
reinitiating, by the second computing device, the transaction with the PoS terminal over the second NFC connection using one of the one or more alternative payment credentials.

15. A non-transitory, computer-readable medium, comprising machine-readable instructions that, when executed by a processor of a first computing device, cause the first computing device to at least:
obtain, from a user via a user interface shown on the display of the first computing device, a plurality of domain controls and a list of participants;
send a request for a shared token to an issuer service, the request for the shared token including at least the domain controls and the list of participants;
receive, from the issuer service, the shared token;
establish an NFC connection with a second computing device using a near-field communication (NFC) transceiver; and
send, via the NFC connection, the shared token to the second computing device.

16. The non-transitory, computer-readable medium of claim 15, wherein the NFC connection is a first NFC connection and the machine-readable instructions, when executed by the processor, further cause the first computing device to at least:
establish a second NFC connection with a point-of-sale (PoS) terminal; and
initiate a transaction with the PoS terminal over the second NFC connection using the shared token.

17. The non-transitory, computer-readable medium of claim 16, wherein the machine-readable instructions, when executed by the processor, further cause the first computing device to at least:
obtain, from the second computing device, a payment distribution calculation; and
send an approval of the payment distribution calculation to the issuer service.

18. The non-transitory, computer-readable medium of claim 16, wherein the machine-readable instructions, when executed by the processor, further cause the first computing device to at least receive a notification from the issuer service that the transaction is approved, wherein the shared token distributes payment of the transaction among the list of participants according to the plurality of domain controls.

19. The non-transitory, computer-readable medium of claim 16, wherein the user interface is a first user interface and the machine-readable instructions, when executed by the processor, further cause the first computing device to at least:
receive a notification from the issuer service that the transaction is declined, wherein the transaction fails to comply with at least one of the plurality of domain controls;
present an option to complete the transaction with one or more alternative payment credentials through a second user interface shown on the display of the first computing device; and
reinitiate the transaction with the PoS terminal over the second NFC connection using one of the one or more alternative payment credentials.

20. The non-transitory, computer-readable medium of claim 15, wherein at least one of the plurality of domain controls is one of at least a date range, a location restriction, a maximum amount, or a payment distribution list.
